(19) United States
(12) Patent Application Publication
(10) Pub. No.: US 2026/0061357 A1
(43) Pub. Date: Mar. 5, 2026

(54) METHANE PURIFICATION APPARATUS

(71) Applicant: ISUZU MOTORS LIMITED, Yokohama-shi (JP)

(72) Inventors: Teppei OHORI, Fujisawa-shi (JP); Ryusuke FUJINO, Fujisawa-shi (JP); Hisashi OZAWA, Fujisawa-shi (JP)

(21) Appl. No.: 19/300,706

(22) Filed: Aug. 15, 2025

(30) Foreign Application Priority Data
Sep. 4, 2024 (JP) 2024-152460

(51) Int. Cl. B01D 51/10; B01D 53/86

(52) U.S. Cl. CPC B01D 51/10; B01D 53/8668; B01D 53/8696; B01D 2251/104; B01D 2255/20738; B01D 2255/20746; B01D 2255/50; B01D 2257/7025; B01D 2258/06

(57) ABSTRACT

A methane purification apparatus includes: a flow path through which a first gas containing methane flows; an ozone supply unit that supplies ozone to the first gas; a heating unit that heats a second gas containing the first gas flowing through the flow path and ozone supplied by the ozone supply unit; a catalyst that is provided downstream of the heating unit in the flow path and decomposes methane contained in the second gas; and a temperature control unit that causes the heating unit to heat the second gas so that the second gas falls within a range, which indicates temperatures at which ozone does not decompose in a predetermined time period and at which condensation of water vapor contained in the second gas is suppressed.

### CROSS REFERENCE TO RELATED APPLICATIONS

The present application claims priority to Japanese Patent Application number 2024-152460, filed on Sep. 4, 2024, contents of which are incorporated herein by reference in its entirety.

### BACKGROUND OF THE INVENTION

The present disclosure relates to a methane purification apparatus. Conventional pollutant treatment methods remove methane contained in a gas containing methane and ozone and having a temperature within a predetermined range by bringing the gas into contact with a catalyst and oxidizing the methane with ozone (for example, Japanese Unexamined Patent Application Publication No. 2021-505376).

As the temperature of methane increases, it becomes more likely to react on a catalyst, whereas as the temperature of ozone increases, it becomes more likely to decompose itself. As a result, it becomes difficult to oxidize methane. Therefore, a measure of raising the temperature to a temperature at which ozone is less likely to decompose and allowing methane and ozone to react can be considered. However, in this case, water condensed from water vapor contained in the gas adheres to the catalyst, making it difficult for methane and ozone to react on the catalyst.

### BRIEF SUMMARY OF THE INVENTION

The present disclosure has been made in view of these points, and it aims to allow methane and ozone to react while suppressing the adhesion of water to a catalyst.

A methane purification apparatus according to the present disclosure including: a flow path through which a first gas containing methane flows; an ozone supply unit that supplies ozone to the first gas; a heating unit that heats a second gas containing the first gas flowing through the flow path and ozone supplied by the ozone supply unit; a catalyst that is provided downstream of the heating unit in the flow path and decomposes methane contained in the second gas; and a temperature control unit that causes the heating unit to heat the second gas so that the second gas falls within a first temperature range, which indicates temperatures at which ozone does not decompose in a predetermined time period and at which condensation of water vapor contained in the second gas is suppressed.

### BRIEF DESCRIPTION OF THE DRAWINGS

FIG. 1 is a diagram showing an overview of a methane purification apparatus 1 according to the present embodiment.

FIG. 2 is a diagram showing an example of the temperature of a catalyst 25.

FIG. 3 is a diagram showing an example of the temperature of the catalyst 25.

FIG. 4 is a diagram showing an example of a methane decomposition rate map.

FIG. 5 is a diagram showing an example of a processing sequence in the methane purification apparatus 1.

### DETAILED DESCRIPTION OF THE INVENTION

Hereinafter, the invention will be described through embodiments of the invention. The below embodiments, however, are not intended to limit the invention according to the claims, and all combinations of features described in the embodiments are not necessarily essential to the solutions of the invention.

### Overview of a Methane Purification Apparatus 1

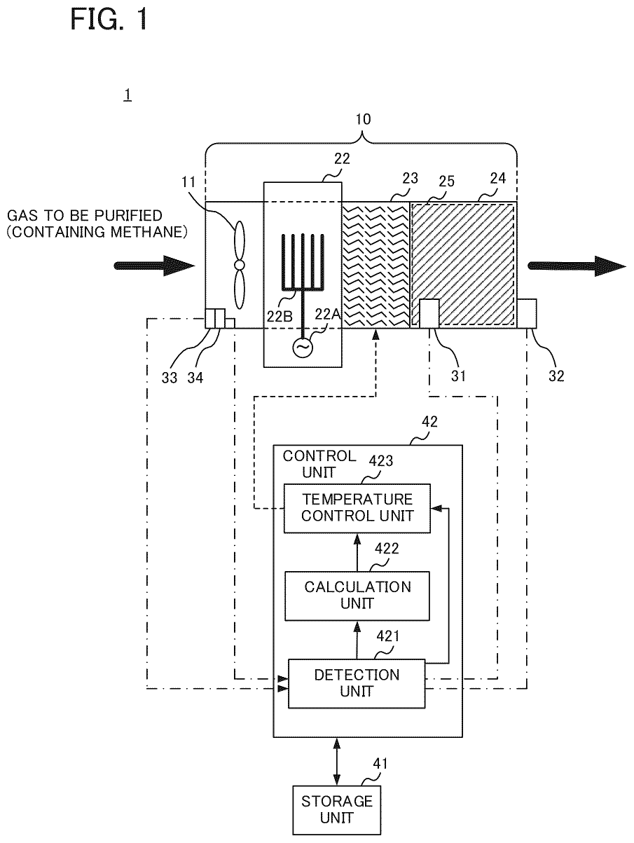

FIG. 1 is a diagram showing an overview of a methane purification apparatus 1 according to the present embodiment. The methane purification apparatus 1 illustrated in FIG. 1 includes a flow path 10, an intake unit 11, an ozone supply unit 22, a heating unit 23, a methane decomposition unit 24, a temperature sensor 31, a color sensor 32, a temperature sensor 33, a humidity sensor 34, a storage unit 41, and a control unit 42. The methane purification apparatus 1 is an apparatus that decomposes methane contained in air to generate water and carbon dioxide.

The flow path 10 is a flow path through which air containing methane (hereinafter referred to as “first gas”) flows. The intake unit 11 is, for example, an intake fan, and draws the first gas into the flow path 10 from outside the flow path 10.

The ozone supply unit 22 is provided downstream of the intake unit 11 and upstream of the heating unit 23 in the flow path 10, and supplies ozone to the first gas drawn in by the intake unit 11. The ozone supply unit 22 includes, for example, an AC power source 22a and electrodes 22b covered with a dielectric such as glass, and performs a process of generating ozone by applying an AC voltage to the electrodes 22b by the AC power source 22a (so-called silent discharge method). The ozone supply unit 22 may generate ozone by performing a process in which discharge occurs on the surface of a dielectric that covers the electrodes (so-called, creeping discharge method), a process in which water is electrolyzed (so-called, electrolysis method), or a process in which ultraviolet light is irradiated onto the first gas (so-called, ultraviolet lamp method). By supplying the generated ozone to the first gas, the ozone supply unit 22 generates a second gas containing the first gas and ozone.

The heating unit 23 is provided downstream of the ozone supply unit 22 and upstream of the methane decomposition unit 24 in the flow path 10, and heats the second gas containing the first gas flowing through the flow path 10 and ozone supplied by the ozone supply unit 22. The heating unit 23 includes, for example, a heating wire such as a nichrome wire that converts electrical energy into thermal energy by receiving a supply of electricity, and heats the second gas by exchanging heat between the heating wire to which electricity has been input and the second gas.

Ozone contained in the second gas is thermally decomposed when the second gas exceeds a predetermined temperature (for example, 150° C.). However, when ozone comes into contact with a metal, thermal decomposition is more likely to occur even if the temperature of the metal is lower than the predetermined temperature. Therefore, the heating unit 23 includes a carrier, on the surface of which a substance that is less likely to promote ozone decomposition is supported as a coating layer. For example, the heating unit 23 includes a carrier whose surface supports a coating layer composed of Teflon, silica, or titania. With this configuration, the heating unit 23 can heat the second gas while reducing the likelihood of ozone decomposition caused by contact between ozone and the heating unit 23. The material of the carrier of the heating unit 23 may be the same as the material of the coating layer of the heating unit 23.

The methane decomposition unit 24 is provided downstream of the heating unit 23 in the flow path 10, accommodates a catalyst 25 that decomposes methane contained in the second gas, and generates water and carbon dioxide by decomposing methane by causing ozone and methane contained in the second gas to react on the catalyst 25. The catalyst 25 includes a carrier having a predetermined structure and a coating layer supported on the surface of the carrier. The predetermined structure is, for example, a honeycomb structure, a corrugated structure, a mesh structure, or a porous structure. The material of the carrier is, for example, cordierite, silicon carbide, aluminum titanate, stainless steel, iron-chromium aluminum alloy, glass wool, glass fiber, or titanium. The coating layer includes, for example, zeolite, iron ion-exchanged zeolite, or cobalt ion-exchanged zeolite. The region of the surface of the carrier may include a region that does not support the coating layer.

The temperature sensor 31 is a sensor for detecting the temperature of the second gas flowing through the methane decomposition unit 24, which is provided on the inner wall surface of the methane decomposition unit 24, and is, for example, a thermistor or a thermocouple. The color sensor 32 is a sensor for detecting the color of the coating layer of the catalyst 25 provided downstream of the methane decomposition unit 24 in the flow path 10, and detects the color of the coating layer of the catalyst 25 on the basis of, for example, a reflected light of the light irradiating the catalyst 25.

The temperature sensor 33 is a sensor for detecting the temperature of the first gas provided upstream of the intake unit 11 in the flow path 10, and is, for example, a thermistor or a thermocouple. The humidity sensor 34 is a sensor for detecting the humidity of the first gas provided upstream of the intake unit 11 in the flow path 10, and includes, for example, a moisture sensitive agent sandwiched between electrodes. The temperature sensor 33 and the humidity sensor 34 may be provided downstream of the intake unit 11 and upstream of the ozone supply unit 22 in the flow path 10.

The storage unit 41 includes, for example, a storage medium such as a ROM (Read Only Memory), a RAM (Random Access Memory), a hard disk drive (HDD), or a solid state drive (SSD). The storage unit 41 stores programs executed by the control unit 42 and various types of information for decomposing methane contained in the second gas.

The control unit 42 includes a processor such as a CPU (Central Processing Unit). The control unit 42 causes the heating unit 23 to heat the second gas by supplying electricity to the heating unit 23, and decomposes methane contained in the second gas by causing ozone contained in the second gas heated by the heating unit 23 to react with methane on the catalyst 25. The control unit 42 may be configured by a single processor, or may be configured by a plurality of processors or a combination of one or more processors and an electronic circuit.

Although methane becomes more easily decomposed on the catalyst 25 as the temperature increases, the amount of ozone that reacts with methane decreases when the temperature exceeds a predetermined temperature due to thermal decomposition of ozone. To address this, the control unit 42 heats the second gas to a temperature (for example, 50° C.) at which ozone is less likely to thermally decompose, thereby allowing ozone and methane to react on the catalyst 25 while suppressing the thermal decomposition of ozone. On the other hand, the lower the temperature of the heated second gas, the more likely it is that water, condensed from water vapor contained in the second gas, adheres to the catalyst 25 and obstructs a region (so-called reaction site) where methane and ozone come into contact and react on the catalyst 25, thereby causing a problem in which the reaction between ozone and methane becomes less likely to occur on the catalyst 25.

Therefore, the control unit 42 causes the heating unit 23 to heat the second gas such that the temperature of the second gas is (i) lower than a temperature at which the thermal decomposition of ozone occurs and (ii) higher than a temperature at which water formed by condensation of water vapor is generated. By having the control unit 42 cause the heating unit 23 to heat the second gas in this manner, the methane purification apparatus 1 can decompose methane by causing methane and ozone contained in the second gas to react on the catalyst 25 while suppressing the adhesion of water to the catalyst 25. Hereinafter, the configuration and operation of the control unit 42 will be described in detail.

### Configuration of the Control Unit 42

As illustrated in FIG. 1, the control unit 42 includes a detection unit 421, a calculation unit 422, and a temperature control unit 423. The control unit 42 functions as the detection unit 421, the calculation unit 422, and the temperature control unit 423 by executing the programs stored in the storage unit 41.

The detection unit 421 detects the temperature of the catalyst 25. For example, the detection unit 421 detects the temperature of the catalyst 25 by acquiring the temperature of the second gas flowing through the methane decomposition unit 24, which is detected by the temperature sensor 31, as the temperature of the catalyst 25. The detection unit 421 detects the color of the catalyst 25 by acquiring the color of the coating layer of the catalyst 25 detected by the color sensor 32.

The detection unit 421 detects the temperature of the first gas upstream of the ozone supply unit 22 in the flow path 10 by acquiring the temperature of the first gas detected by the temperature sensor 33. The detection unit 421 detects the humidity of the first gas upstream of the ozone supply unit 22 in the flow path 10 by acquiring the humidity of the first gas detected by the humidity sensor 34.

The calculation unit 422 calculates the amount of water vapor contained in the first gas. For example, the calculation unit 422 calculates the amount of water vapor contained in the first gas on the basis of the absolute humidity of the first gas based on the temperature and humidity of the first gas detected upstream of the ozone supply unit 22 in the flow path 10, and a flow rate of the first gas in the flow path 10.

Specifically, by referencing a humidity map indicating the absolute humidity corresponding to the temperature and humidity stored in the storage unit 41, the calculation unit 422 identifies the absolute humidity of the first gas corresponding to the temperature and the humidity of the first gas detected by the detection unit 421. The calculation unit 422 identifies the intake amount of the intake unit 11 stored in the storage unit 41 as the flow rate of the first gas. The calculation unit 422 calculates, as the amount of water vapor contained in the first gas, a multiplication value obtained by multiplying the identified absolute humidity of the first gas by the flow rate of the first gas.

The calculation unit 422 calculates the amount of water vapor per unit weight of the catalyst 25 on the basis of the amount of water vapor and the weight of the catalyst 25. Specifically, the calculation unit 422 calculates, as the amount of water vapor per unit weight of the catalyst 25, a division value obtained by dividing the calculated amount of water vapor by the weight of the catalyst 25 stored in the storage unit 41. Since the calculation unit 422 operates in this manner, the temperature control unit 423 can cause the heating unit 23 to heat the second gas on the basis of the amount of water vapor contained in the first gas.

The temperature control unit 423 causes the heating unit 23 to heat the second gas by supplying electricity to the heating unit 23. The temperature control unit 423 causes the heating unit 23 to heat the second gas so that the temperature of the second gas falls within a first temperature range. The first temperature range is a range of temperatures indicating a temperature (for example, less than 150° C.) at which ozone does not decompose in a predetermined time period and a temperature (for example, 100° C. or more) at which condensation of water vapor contained in the second gas is suppressed, and is, for example, 100° C. or more and less than 150° C. The predetermined time period is longer than the time period from when the first gas is drawn into the flow path 10 to when the first gas is discharged from the flow path 10, and is, for example, three minutes or more.

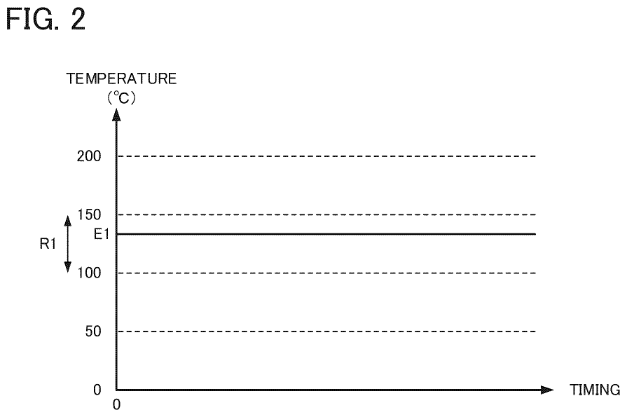

For example, the temperature control unit 423 causes the heating unit 23 to heat the second gas so that the temperature of the catalyst 25 (that is, the temperature of the second gas flowing through the methane decomposition unit 24) detected by the detection unit 421 falls within the first temperature range. FIG. 2 is a diagram showing an example of the temperature of the catalyst 25. The horizontal axis of FIG. 2 indicates timing, and the vertical axis of FIG. 2 indicates the temperature of the catalyst 25. A range R1 shown in FIG. 2 is the first temperature range. As shown in FIG. 2, for example, the temperature control unit 423 causes the heating unit 23 to heat the second gas so that the temperature of the catalyst 25 falls within the range R1. The temperature control unit 423 includes, for example, a feedback controller whose target value is a temperature E1 within the range R1, and starts or stops the heating of the second gas by the heating unit 23 so as to reduce the difference between the temperature of the catalyst 25 and the target value.

By controlling the temperature of the second gas with the temperature control unit 423 as described above, the temperature control unit 423 can suppress a reduction in ozone contained in the second gas due to thermal decomposition and can also suppress the condensation of water vapor contained in the second gas. As a result, the temperature control unit 423 can suppress a shortage of ozone for reaction with methane and can suppress the reaction sites from being blocked by water formed by condensation of the water vapor contained in the second gas. This enables the reaction between methane and ozone on the catalyst 25.

In order to remove the water formed by condensation of the water vapor contained in the second gas and adhered to the catalyst 25, the temperature control unit 423 may cause the heating unit 23 to heat the second gas so that the temperature of the second gas (that is, the temperature of the catalyst 25) temporarily falls within the first temperature range. For example, the temperature control unit 423 causes the heating unit 23 to heat the second gas so that the temperature of the second gas falls within the first temperature range at a predetermined cycle for a predetermined time period, and causes the heating unit 23 to heat the second gas so that the temperature of the second gas falls within a second temperature range after the predetermined time period has elapsed. The predetermined cycle is, for example, one hour, and the predetermined time period is, for example, one minute. The second temperature range is a range of temperatures indicating temperatures lower than the temperatures within the first temperature range and at which ozone does not decompose in a predetermined time period, and is, for example, 50° C. or more and less than 100° C.

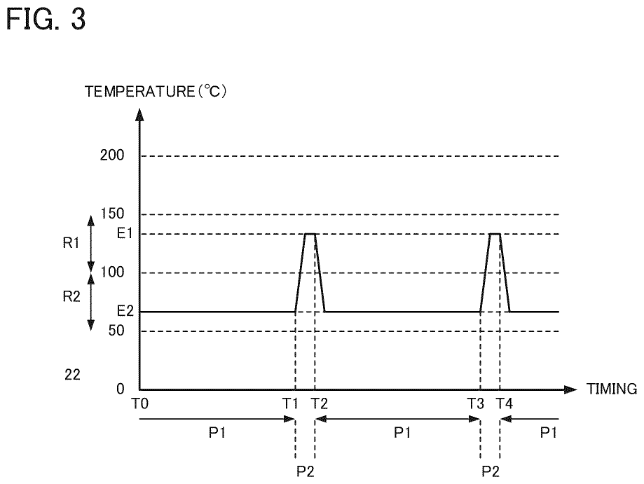

FIG. 3 is a diagram showing an example of the temperature of the catalyst 25. The vertical axis and the horizontal axis of FIG. 3 are the same as the vertical axis and the horizontal axis of FIG. 2, and a range R1 and a temperature E1 shown in FIG. 3 are the same as the range R1 and the temperature E1 shown in FIG. 2. In FIG. 3, a range R2 indicating the second temperature range, a temperature E2 within the range R2, a time period P1 indicating the predetermined cycle, and a time period P2 indicating the predetermined time period are further illustrated. For example, at a timing T1, because the time period P1 has elapsed, the temperature control unit 423 causes the heating unit 23 to heat the second gas to raise the temperature of the second gas (that is, the temperature of the catalyst 25) from the temperature E2 to the temperature E1. Then, at a timing T2, because the time period P2 has elapsed from the timing T1, the temperature control unit 423 causes the heating unit 23 to heat the second gas to lower the temperature of the second gas from the temperature E2 to the temperature E1.

For example, the temperature control unit 423 sets the target value of the feedback controller included in the temperature control unit 423 to the temperature E2 for the time period P1, and sets the target value to the temperature E1 for the time period P2. The temperature control unit 423 then starts or stops the heating of the second gas by the heating unit 23 to reduce the difference between the temperature of the catalyst 25 detected by the detection unit 421 and the target value.

By controlling the temperature of the second gas with the temperature control unit 423 as described above, the temperature control unit 423 can cause ozone and methane to react at the temperature at which ozone is less likely to thermally decompose in the time period P1, and can evaporate the water attached to the catalyst 25 in the time period P2. As a result, after removing the water adhered to the catalyst 25, the temperature control unit 423 can decompose methane while suppressing the thermal decomposition of ozone.

The temperature control unit 423 may determine whether to raise the temperature of the second gas from a temperature within the range R2 to the temperature within the range R1 on the basis of the amount of water vapor contained in the first gas, and cause the heating unit 23 to heat the second gas. In other words, the temperature control unit 423 may determine, on the basis of whether the amount of water vapor contained in the first gas exceeds a threshold value, a range (the range R1 or the range R2) in which the target temperature of the feedback controller falls, and cause the heating unit 23 to heat the second gas so that the temperature of the second gas falls within the determined range.

For example, when the amount of water vapor per unit weight calculated by the calculation unit 422 exceeds the threshold value, the temperature control unit 423 causes the heating unit 23 to heat the second gas so that the temperature of the second gas falls within the range R1. The threshold value is a fixed value of 0.1 or more and 10 or less (for example, 1.0), and is stored in the storage unit 41. For example, when the amount of water vapor per unit weight calculated by the calculation unit 422 is equal to or less than the threshold value, the temperature control unit 423 causes the heating unit 23 to heat the second gas so that the temperature of the second gas falls within the range R2.

By operating in this manner, the temperature control unit 423 can cause the heating unit 23 to heat the second gas so that the temperature of the second gas falls within the range R1 when the amount of water vapor contained in the first gas is large. As a result, even when the water condensed from water vapor contained in the first gas is in a state likely to adhere to the catalyst 25, the temperature control unit 423 can evaporate the water. On the other hand, when the amount of water vapor contained in the first gas is small, the temperature control unit 423 can cause the heating unit 23 to heat the second gas so that the temperature of the second gas falls within the range R2. As a result, even when the water condensed from water vapor contained in the first gas is in a state unlikely to adhere to the catalyst 25, the temperature control unit 423 can cause ozone and methane to react at the temperature at which ozone is less likely to thermally decompose.

The zeolite, iron ion-exchanged zeolite, or cobalt ion-exchanged zeolite included in the coating layer of the catalyst 25 changes color from blue to pink by absorbing moisture. Therefore, the temperature control unit 423 may determine whether to raise the temperature of the second gas from the temperature within the range R2 to the temperature within the range R1 on the basis of the color of the coating layer of the catalyst 25, and cause the heating unit 23 to heat the second gas.

For example, when the color of the catalyst 25 detected by the detection unit 421 is a color indicating that water has adhered to the catalyst 25, the temperature control unit 423 causes the heating unit 23 to heat the second gas so that the temperature of the second gas falls within the range R1. The color indicating that water has adhered is a color containing the largest amount of R among Red Green Blue (RGB), and is, for example, pink. For example, when the color of the catalyst 25 detected by the detection unit 421 is a color indicating that no water has adhered to the catalyst 25, the temperature control unit 423 causes the heating unit 23 to heat the second gas so that the temperature of the second gas falls within the range R2. The color indicating that water is not adhered is a color containing the largest amount of B among RGB, and is, for example, blue.

By operating in this manner, when the catalyst 25 absorbs moisture, the temperature control unit 423 can cause the heating unit 23 to heat the second gas so that the temperature of the second gas falls within the range R1 and evaporate the water contained in the catalyst 25. On the other hand, when the catalyst 25 does not absorb moisture, the temperature control unit 423 can cause the heating unit 23 to heat the second gas so that the temperature of the second gas falls within the range R2, and cause ozone and methane to react on the catalyst 25 in a state in which ozone is less likely to thermally decompose.

The methane decomposition rate (the ratio of the amount of methane decomposed by the catalyst 25 to the amount of methane contained in the second gas that has flowed into the methane decomposition unit 24) corresponding to the temperature of the catalyst 25 varies depending on the type of the coating layer of the catalyst 25. Accordingly, by referencing the methane decomposition rate map stored in the storage unit 41, the temperature control unit 423 may identify a temperature range in which a methane decomposition rate is equal to or higher than a predetermined decomposition rate for the type of the coating layer of the catalyst 25, and determine the identified temperature range as the range R1. The methane decomposition rate map is a map indicating the methane decomposition rate corresponding to the temperature of the catalyst 25 for each type of the coating layer of the catalyst 25.

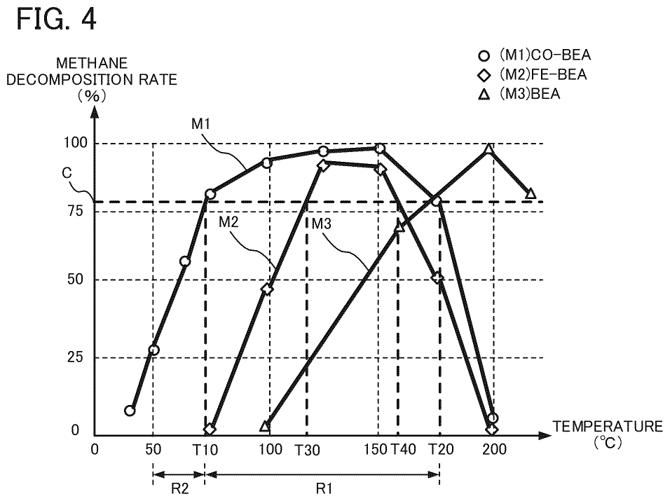

FIG. 4 is a diagram showing an example of the methane decomposition rate map. The horizontal axis of FIG. 4 indicates the temperature of the catalyst 25 (the temperature of the second gas), and the vertical axis of FIG. 4 indicates the methane decomposition rate. In FIG. 4, a catalyst M1, a catalyst M2, and a catalyst M3 are shown as the types of the catalyst 25. The coating layer of the catalyst M1 is a cobalt ion-exchanged zeolite (Co-BEA) in which cobalt is supported on a β-type framework zeolite. The coating layer of the catalyst M2 is an iron ion-exchanged zeolite (Fe-BEA) in which iron is supported on a β-type framework zeolite. The coating layer of the catalyst M3 is a β-type framework zeolite (BEA).

As shown in FIG. 4, when the temperature is less than 150° C., the methane decomposition rate of the catalyst M1 increases with increasing temperature. However, at temperatures of 150° C. or more, the methane decomposition rate decreases as the temperature increases, due to decomposition of ozone by cobalt contained in the catalyst M1 and the thermal decomposition of ozone. In the case of the catalyst M3, when the temperature is less than 200° C., the methane decomposition rate increases with increasing temperature. However, at temperatures of 200° C. or more, the methane decomposition rate decreases as the temperature increases, due to the thermal decomposition of ozone. As described above, the methane decomposition rate varies depending on the type of the coating layer of the catalyst 25.

For example, by referencing information indicating the type of the coating layer of the catalyst 25 stored in the storage unit 41, the temperature control unit 423 identifies the type of the coating layer of the catalyst 25 and determines a temperature range, in which the methane decomposition rate is equal to or higher than a predetermined decomposition rate in the identified coating layer, as the range R1. Specifically, the temperature control unit 423 identifies that the type of the coating layer of the catalyst 25 is the coating layer of the catalyst M1 (cobalt ion-exchanged zeolite). Then, in the methane decomposition rate map shown in FIG. 4, the temperature control unit 423 determines, as the range R1, the temperature range “a temperature of T10° C. or more and less than T20° C.”, in which the methane decomposition rate of the catalyst M1 is equal to or higher than a decomposition rate C, and determines the temperature range “a temperature of 50° C. or more and less than T10° C.” as the range R2. By operating in this manner, the temperature control unit 423 can determine optimal ranges R1 and R2 for decomposing methane according to the type of the coating layer of the catalyst 25.

As shown in FIG. 4, the range R1 of the catalyst M2 (a temperature of T30° C. or more and less than T40° C.), in which the methane decomposition rate is equal to or higher than the decomposition rate C, is smaller than the range R1 of the catalyst M1, and the catalyst M2 cannot decompose methane at temperatures within the range R2 of the catalyst M1. Therefore, the range of target temperatures of the catalyst M2 is narrower than the range of the temperatures of the catalyst M1 when the temperature control unit 423 causes the heating unit 23 to heat the second gas. Therefore, the temperature control unit 423 may switch whether to cause the heating unit 23 to heat the second gas using only the range R1 as illustrated in FIG. 2 or to cause the heating unit 23 to heat the second gas using the ranges R1 and R2 as illustrated in FIG. 3, according to the type of the coating layer of the catalyst 25.

For example, the temperature control unit 423 determines the range R1 by referencing (i) the information indicating the type of the coating layer of the catalyst 25 and (ii) the methane decomposition rate map indicating the methane decomposition rate corresponding to the temperature of the catalyst 25 for each type of the coating layer of the catalyst 25, which are stored in the storage unit 41. When the difference between the maximum value and the minimum value of the temperatures within the range R1 is greater than a temperature threshold value, the temperature control unit 423 determines the range R2, which indicates temperatures lower than the temperatures within the range R1 and at which ozone does not decompose in the predetermined time period.

On the other hand, when the difference between the maximum value and the minimum value of the temperatures within the range R1 is equal to or less than the temperature threshold value, the temperature control unit 423 does not determine the range R2. The temperature threshold value is, for example, 50° C. When the range R2 is determined, the temperature control unit 423 causes the heating unit 23 to heat the second gas using the ranges R1 and R2, and when the range R2 is not determined, causes the heating unit 23 to heat the second gas using only the range R1.

For example, when the catalyst 25 is the catalyst M1, the temperature control unit 423 determines the ranges R1 and R2 by referencing the methane decomposition rate map. Then, as illustrated in FIG. 3, the temperature control unit 423 causes the heating unit 23 to heat the second gas so that the difference between the temperature E1 and the temperature of the second gas becomes small for the time period P1, and causes the heating unit 23 to heat the second gas so that the difference between the temperature E2 and the temperature of the second gas becomes small for the time period P2.

On the other hand, when the catalyst 25 is the catalyst M2, the temperature control unit 423 determines the range R1 by referencing the methane decomposition rate map. Then, as illustrated in FIG. 2, the temperature control unit 423 causes the heating unit 23 to heat the second gas so that the difference between the temperature E1 and the temperature of the second gas becomes small.

By operating in the manner described above, when the range of target temperatures for heating the second gas is smaller than a predetermined range, the temperature control unit 423 can heat the second gas using only the range R1. On the other hand, when the range of target temperatures for heating the second gas is larger than the predetermined range, the temperature control unit 423 can heat the second gas using the ranges R1 and R2. As a result, the temperature control unit 423 can heat the second gas in a method suitable for the type of the coating layer of the catalyst 25.

### Process Sequence in the Methane Purification Apparatus 1

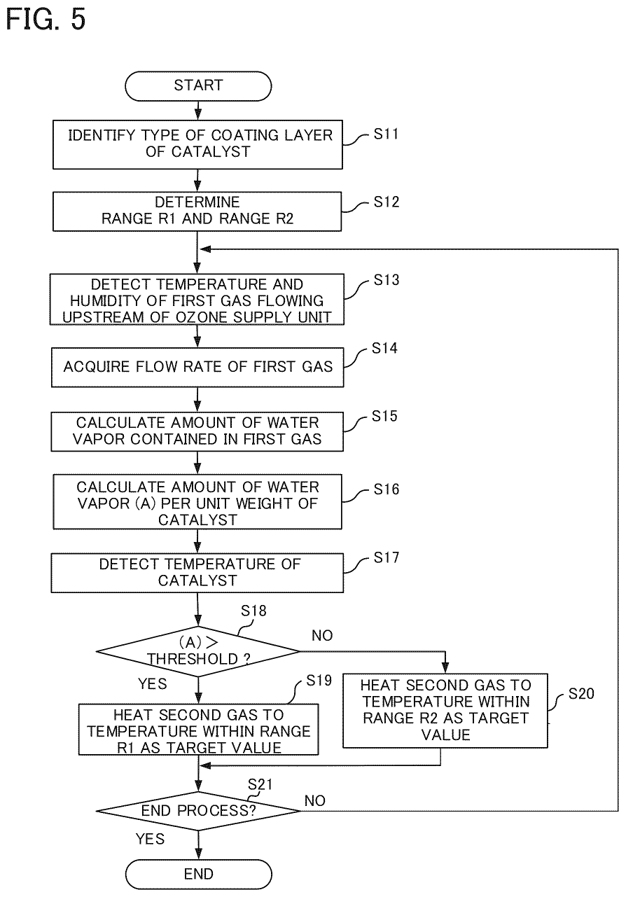

FIG. 5 is a diagram showing an example of a processing sequence in the methane purification apparatus 1. The processing sequence illustrated in FIG. 5 is a processing sequence in which the temperature control unit 423 causes the heating unit 23 to heat the second gas on the basis of the amount of water vapor contained in the first gas.

The temperature control unit 423 identifies the type of the coating layer of the catalyst 25 by referencing the storage unit 41 (step S11). The temperature control unit 423 determines the range R1 and the range R2 corresponding to the identified type of the coating layer of the catalyst 25 by referencing a methane decomposition rate map stored in the storage unit 41 (step S12). As an example, in a case where the type of the coating layer of the catalyst 25 identified in Step S11 is the coating layer of a catalyst M1, the temperature control unit 423 determines, as the range R1, the temperature rage “a temperature of T10° C. or more and less than T20° C.”, in which the methane decomposition rate of the catalyst M1 is equal to or higher than a decomposition rate C, by referencing the methane decomposition rate map illustrated in FIG. 4. Then, the temperature control unit 423 determines the temperature range “a temperature of 50° C. or more and less than T10° C.” as the range R2.

The detection unit 421 detects the temperature and humidity of the first gas flowing upstream of the ozone supply unit 22 (step S13). The detection unit 421 detects the temperature of the first gas flowing upstream of the ozone supply unit 22, for example, by acquiring the temperature detected by the temperature sensor 33. The detection unit 421 detects the humidity of the first gas flowing upstream of the ozone supply unit 22, for example, by acquiring the humidity detected by the humidity sensor 34.

The calculation unit 422 acquires the intake amount of the intake unit 11 stored in the storage unit 41 as a flow rate of the first gas (step S14). By referencing a humidity map stored in the storage unit 41, the calculation unit 422 identifies the absolute humidity corresponding to the temperature and humidity of the first gas detected by the detection unit 421 and calculates, as the amount of water vapor contained in the first gas, a multiplication value obtained by multiplying the identified absolute humidity by the flow rate of the first gas (step S15). The calculation unit 422 calculates, as the amount of water vapor per unit weight of the catalyst 25, a division value obtained by dividing the calculated amount of water vapor by the weight of the catalyst 25 stored in the storage unit 41 (step S16).

The detection unit 421 detects the temperature of the catalyst 25 (that is, the temperature of the second gas flowing through the methane decomposition unit 24) by acquiring the temperature detected by the temperature sensor 31 (Step S17). If the amount of water vapor per unit weight of the catalyst 25 exceeds a threshold value (YES in step S18), the temperature control unit 423 causes the heating unit 23 to heat the second gas to a temperature within the range R1 as a target value (step S19). For example, the temperature control unit 423 causes the heating unit 23 to heat the second gas so as to reduce the difference between a temperature E1 illustrated in FIG. 3 and the temperature of the catalyst 25.

On the other hand, if the amount of water vapor per unit weight of the catalyst 25 is equal to or less than the threshold value (NO in step S18), the temperature control unit 423 causes the heating unit 23 to heat the second gas to a temperature within the range R2 as the target value (step S20). For example, the temperature control unit 423 causes the heating unit 23 to heat the second gas so as to reduce the difference between a temperature E2 illustrated in FIG. 3 and the temperature of the catalyst 25.

If the methane purification apparatus 1 does not receive an operation to end the process (NO in step S21), the methane purification apparatus 1 repeats the operations from step S13 to step S20. If the methane purification apparatus 1 receives the operation to end the process (YES in Step S21), the methane purification apparatus 1 ends the process.

### Modification

In the above description, the operation in which the methane purification apparatus 1 decomposes methane contained in air is exemplified, but the operation is not limited thereto. The methane purification apparatus 1 may decompose methane contained in exhaust gas discharged from equipment or a vehicle installed in a plant. As one example, the methane purification apparatus 1 may be provided in an exhaust passage downstream of an engine included in the vehicle, and may decompose methane contained in exhaust gas of the engine.

### Effects of the Methane Purification Apparatus 1

As described above, the methane purification apparatus 1 includes: the flow path 10 through which the first gas containing methane flows; the ozone supply unit 22 that supplies ozone to the first gas, the heating unit 23 that heats the second gas containing the first gas flowing through the flow path 10 and ozone supplied by the ozone supply unit 22; the catalyst 25 that is provided downstream of the heating unit 23 in the flow path 10 and decomposes methane contained in the second gas; and the temperature control unit 423 that causes the heating unit 23 to heat the second gas so that the temperature of the second gas falls within the range R1, which indicates temperatures at which ozone does not decompose in the predetermined time period and at which condensation of water vapor contained in the second gas is suppressed.

With the methane purification apparatus 1 configured in this manner, it can control the temperature of the second gas (the temperature of the catalyst 25) to a temperature at which ozone is less likely to thermally decompose and water vapor contained in the second gas is less likely to condense. Therefore, the methane purification apparatus 1 can suppress both the blockage of reaction sites caused by water adhering to the catalyst 25 and the reduction of ozone that reacts with methane contained in the second gas due to thermal decomposition. As a result, the methane purification apparatus 1 can decompose methane by supplying a sufficient amount of ozone to decompose methane contained in the second gas and allowing methane and ozone to react on the catalyst 25.

The present disclosure is explained based on the exemplary embodiments. The technical scope of the present disclosure is not limited to the scope explained in the above embodiments and it is possible to make various changes and modifications within the scope of the disclosure. For example, all or part of the apparatus can be configured with any unit which is functionally or physically dispersed or integrated. Further, new exemplary embodiments generated by arbitrary combinations of them are included in the exemplary embodiments. Further, effects of the new exemplary embodiments brought by the combinations also have the effects of the original exemplary embodiments.

What is claimed is:

1. A methane purification apparatus comprising:
a flow path through which a first gas containing methane flows;
an ozone supply unit that supplies ozone to the first gas;
a heating unit that heats a second gas containing the first gas flowing through the flow path and ozone supplied by the ozone supply unit;
a catalyst that is provided downstream of the heating unit in the flow path and decomposes methane contained in the second gas; and
a temperature control unit that causes the heating unit to heat the second gas so that the second gas falls within a first temperature range, which indicates temperatures at which ozone does not decompose in a predetermined time period and at which condensation of water vapor contained in the second gas is suppressed.

2. The methane purification apparatus according to claim 1, further comprising:
a detection unit that detects a temperature of the catalyst, wherein the temperature control unit causes the heating unit to heat the second gas so that the temperature detected by the detection unit falls within the first temperature range.

3. The methane purification apparatus according to claim 1, wherein the catalyst includes zeolite, iron ion-exchanged zeolite, or cobalt ion-exchanged zeolite.

4. The methane purification apparatus according to claim 1, wherein the heating unit has a carrier carrying Teflon (registered trademark), silica, or titania on its surface.

5. The methane purification apparatus according to claim 1, wherein the temperature control unit causes the heating unit to heat the second gas so that the temperature of the second gas falls within the first temperature range at a predetermined cycle for a predetermined time period, and after the predetermined time period has elapsed, causes the heating unit to heat the second gas so that the temperature of the second gas falls within a second temperature range, which indicates temperatures lower than temperatures within the first temperature range and at which the ozone does not decompose in a predetermined time period.

6. The methane purification apparatus according to claim 1, further comprising:
a calculation unit that calculates an amount of water vapor contained in the first gas on the basis of the absolute humidity of the first gas based on a temperature and humidity of the first gas detected upstream of the ozone supply unit in the flow path, and a flow rate of the first gas in the flow path, and
calculates an amount of the water vapor per unit weight of the catalyst on the basis of the amount of water vapor and the weight of the catalyst, wherein the temperature control unit causes the heating unit to heat the second gas so that the temperature of the second gas falls within the first temperature range when the amount of water vapor per unit weight exceeds a threshold value, and causes the heating unit to heat the second gas so that the temperature of the second gas falls within a second temperature range, which indicates temperatures lower than temperatures within the first temperature range and at which ozone does not decompose in a predetermined time when the amount of water vapor per unit weight is equal to or less than the threshold value.

7. The methane purification apparatus according to claim 1, further comprising:
a detection unit that detects a color of the catalyst, wherein the temperature control unit causes the heating unit to heat the second gas so that the temperature of the second gas falls within the first temperature range when the color of the catalyst detected by the detection unit is a color indicating that water has adhered to the catalyst, and causes the heating unit to heat the second gas so that the temperature of the second gas falls within the second temperature range, which indicates temperatures lower than temperatures within the first temperature range and at which ozone does not decompose in a predetermined time period when the color of the catalyst detected by the detection unit is a color indicating that no water has adhered to the catalyst.

8. The methane purification apparatus according to claim 1, further comprising:
a storage unit that stores a methane decomposition rate map indicating a methane decomposition rate corresponding to the temperature of the catalyst for each type of the catalyst, wherein, by referencing the methane decomposition rate map, the temperature control unit identifies a temperature range in which the methane decomposition rate is equal to or higher than a predetermined decomposition rate for the type of the catalyst and determines the temperature range as the first temperature range.

9. The methane purification apparatus according to claim 1, wherein by referencing (i) information indicating the type of the coating layer of the catalyst and (ii) a methane decomposition rate map indicating a methane decomposition rate corresponding to the catalyst for each type of the coating layer of the catalyst, which are stored in the storage unit, the temperature control unit determines the first temperature range, and when a difference between a maximum value and a minimum value of temperatures within the first temperature range is greater than a temperature threshold value, determines a second temperature range, which indicates temperatures lower than the first temperature range and at which the ozone does not decompose in a predetermined time period.

10. The methane purification apparatus according to claim 9, wherein the temperature control unit causes the heating unit to heat the second gas using the first temperature range and the second temperature range when the second temperature range is determined, and causes the heating unit to heat the second gas using only the first temperature range when the second temperature range is not determined.
